(19) United States
(12) Patent Application Publication
(10) Pub. No.: US 2006/0277216 A1
(43) Pub. Date: Dec. 7, 2006

(54) Portable media storage device with wireless network connectivity

(75) Inventor: Tzvika Shukhman, Savion (IL)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: METALINK LTD., Yakum Business Park (IL)

(21) Appl. No.: 11/443,933

(22) Filed: May 31, 2006

Related U.S. Application Data
(60) Provisional application No. 60/686,441, filed on Jun. 2, 2005.

(51) Int. Cl. G06F 17/00

(52) U.S. Cl. 707/104.1

(57) ABSTRACT

Portable media storage device with wireless network connectivity. A portable storage device is proposed for enabling wireless communication between the portable storage device and one or more multimedia terminals and/or devices. The portable storage device includes a wireless circuitry for communicating with any of the wireless devices. When communicating on the wireless network, the portable storage device can transmit to any of the wireless devices data stored in its memory. Additionally, data streaming between portable storage device and at least one multimedia devices and or terminals may be performed simultaneously.

### FIELD OF THE INVENTION

The present invention relates to a device for digital data storage combined with wireless transfer of data between the storage device and one or more multimedia devices, multimedia terminals and or computer devices.

### BACKGROUND OF THE INVENTION

Wireless technologies have become so ubiquitous in the last few years that we can hardly imagine our life without them. Cell phones, Cordless phones, wireless computer networks and wireless PDAs all provide us with flexibility that makes our lives more convenient. Naturally, developments in wireless technologies lead to an increasing demand for portable devices that combine high performance which have small size and are lightweight. Whereas modem processors may be miniaturised while retaining the high performance processing ability, the small size of the portable devices limits their storage capacity.

One form of solution to the above-mentioned problem is to offer these devices an access to more storage via wireless means.

Another solution is to have a server on a communication network (whether lined or wired) having high capacity of storage. However, this solution is further complicated, comprise more elements than needed to establish a local storage solution with wireless connectivity. Moreover, it may not be cost-effective for every user.

Several other solutions for alleviating the storage bottleneck of portable device have been suggested so far and are known in the art.

US2004225762 discloses a method and devices for data transfer. A storage device is functioned to transmit data to other devices, and may also serve as a relay for data transference from one device to another. This reference lacks the ability to communicate simultaneously with at least two devices. A property that is sought after if the storage device is meant to solve the local storage shortage in the home/office environment.

US2006048196 discloses a network system for streaming, uploading, or transferring digital content from external media sources over wireless links to the network of wireless interactive display apparatus. The focus in this reference is on the network rather than on standalone storage device. The network system lacks the ability of simultaneous streaming data to a plurality of multimedia devices and/or terminals.

Therefore, there is a need for a standalone, simply implemented portable storage device for multimedia content on one hand, but with high wireless connectivity properties, which is capable of streaming data to several devices simultaneously on the other hand.

### SUMMARY OF THE INVENTION

The present invention solves the above-mentioned memory shortage problem by introducing a portable storage device into a wireless network environment. The invention thus synergizes effectively two technologies: portable storage and wireless network connectivity.

According to one embodiment of the invention, a portable storage wireless device is being disclosed, said device comprising means for storing data and means for connecting to a wireless network, coupled to said means for storing data. Said means for connecting to a wireless network are configured to stream data between said means for storing data and at least one wireless device.

Specifically, said portable data storage device having wireless connectivity, comprising a storage module, a processor and a wireless circuitry. Said processor is coupled to said storage module and to said wireless circuitry. Said processor is configured to command said wireless circuitry to stream data between said storage module and at least one wireless.

According to the preferred embodiment of the invention data streaming between said means for storing data and said at least one wireless is performed simultaneously.

### BRIEF DESCRIPTION OF DRAWINGS

Further features of the present invention, as well as the structure and operation of various embodiments of the present invention, are described in details below with reference to the accompanying drawings:

FIG. 1 is a block diagram showing the environment of the invention;

FIG. 2 is a block diagram showing the functional structure of the portable storage device; and

FIG. 3 is a block diagram showing another embodiment of the present invention.

### DETAILED DESCRIPTION OF THE INVENTION

In the following description, numerous specific details are set forth to provide a more thorough understanding of the invention. However, it will be apparent to one of skill in the art that the invention may be practiced without one or more of these specific details. In other instances, well-known features have not been described in order to avoid obscuring the invention.

The present invention provides a new and useful device for storing and transferring data between electronic devices and in particular to facilitate data transfer between multimedia devices and terminals and a storage device communicating on the same wireless network.

Generally, the invention proposes a self-powered data storage device (hereinafter, “portable storage device” or “storage device”) that includes a wireless circuitry for selectively entering communication with a personal computer or one or more multimedia devices (e.g. DVD) and/or multimedia terminals (e.g. TV). More such devices having wireless connectivity may include: PDA, DVD, VCR, TV and are hereinafter related to as wireless devices or wireless terminals.

Whenever the portable storage device is communicating with any of the multimedia terminals and devices it can transmit any data stored on its storage module to any of the multimedia wireless devices and wireless terminals.

According to one embodiment of the invention, a portable storage device having wireless connectivity is being disclosed, said device comprising means for storing data and means for connecting to a wireless network, coupled to said means for storing data. Said means for connecting to a wireless network are configured to stream data between said means for storing data and at least one wireless device.

Specifically, said portable data storage device having wireless connectivity, comprising a storage module, a processor and a wireless circuitry. Said processor is coupled to said storage module and to said wireless circuitry. Said processor is configured to command said wireless circuitry to stream data between said storage module and at least one wireless device.

According to the preferred embodiment of the invention, the portable storage device will be able to communicate with several multimedia devices and terminals simultaneously. For example the portable storage device may perform video streaming to a TV terminal, while downloading the entire audio files collection from an MP3 player at the same time. The simultaneous streaming to a plurality of wireless devices may be of the same multimedia data (e.g. streaming the same video to several TV sets). Alternatively, the simultaneous streaming may be of different multimedia data transferred respectively to different wireless devices.

According to one embodiment of the present invention, the storage device will maintain its portability by having its own power module, preferably in the form of rechargeable batteries.

Specifically, due to the storage-focused nature of the present invention, the portable storage device will accommodate a storage module that is larger than in most other portable electronic devices, at least 1 GB or at least 10 GB. The storage will be implemented for example with a magnetic disk drive, rewriteable CD/DVD or any other suitable non volatile memory such as EEPROM, flash or any other memory technology that may become available in the future.

According to one aspect of the present invention, the wireless circuitry will operate by electromagnetic waves, and most preferably by IR or RF waves. The wireless circuitry may use any wireless network in any communication protocol presently in existence, for example IEEE802.11xx, Bluetooth or IrDA or any protocol that may become available in the future. Clearly, said wireless network may use to connect said portable storage device to the Internet.

According to another embodiment of the present invention, the portable storage device may be capable of receiving/transmitting in multiple formats, so that it can, for example interpret between portable devices that use different formats.

In addition to its wireless capabilities, the storage device will retain its wired connectivity utilizing different protocols, for example USB, Ethernet, DVI, etc.

Generally, the media types that may be stored on the storage device are not limited in any way to specific types. In particular the storage device may store any existing file type that can be stored on a PC or any file type that may be stored on a PC in the future. For example: audio files, still pictures and motion picture formats (including HDTV).

The storage device will be able to enter communication with any portable device that uses the above-mentioned file types, for example: TV's and monitors for viewing pictures and motion pictures, personal computers for downloading and uploading information, mobile phones, headphones, gaming consoles and other storage devices as well.

Preferably, the storage device will be able to connect to the Internet through devices that enable such connection (e.g. xDSL or cable modem) and store data downloaded from the Internet.

In addition to its portable functionality, the storage device can be hooked up on a central base station. By this the storage device may serve as a PVR or store data stored on any of the other portable devices in the house or store data downloaded from the Internet for future use. The base station expands the storage capacity of the storage device and also extends the range of wireless communication to cover the whole house.

Advantageously, the portable storage device may also serve as a wireless virtual memory manager for a local wireless network comprising the above-mentioned wireless devices. Specifically, a device connected to the portable storage device via said wireless network may send a request for certain data held on any of the other devices connected via said wireless network to said portable storage device. As a result, the requested data is transferred to said portable storage device from the device holding said requested data and subsequently relayed to the requesting device.

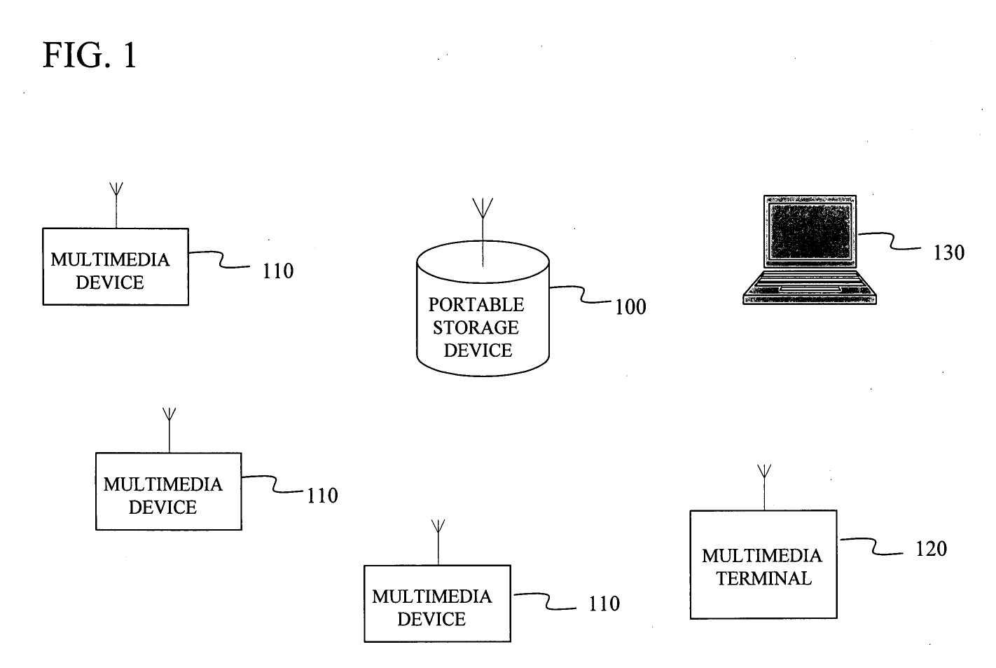

Referring now to FIG. 1, the portable storage device 100 is shown in its environment. Said environment may include a plurality of devices having wireless connectivity, such as a multimedia device 110, a multimedia terminal 120 and a personal computer 130. Said portable storage device 100 can communicate with each of said devices having wireless connectivity. Preferably, the portable storage device 100 may communicate simultaneously with two or more other devices for example, by transmitting different video streams to multiple TV terminals.

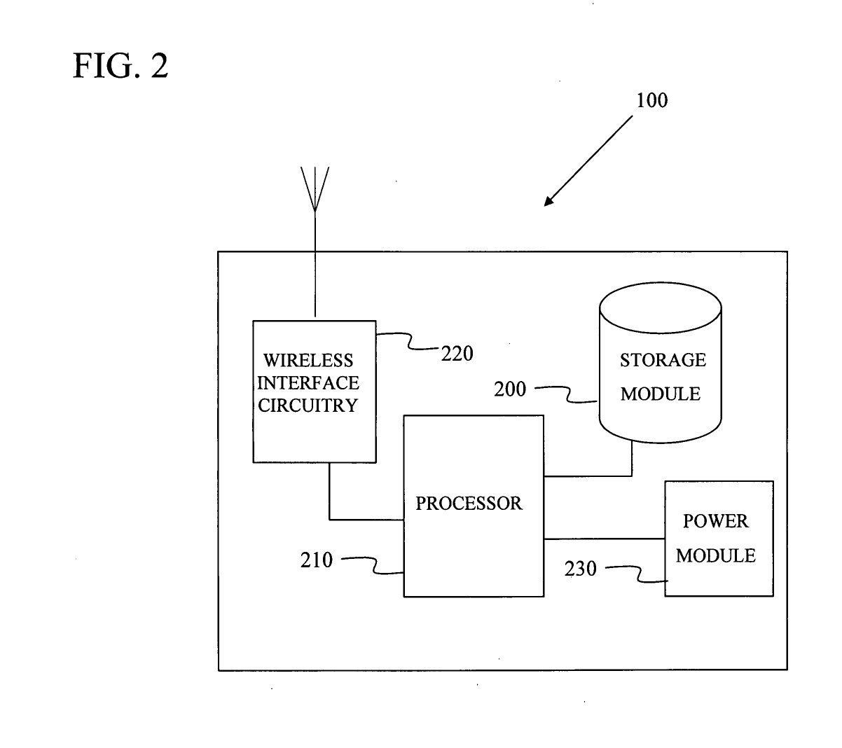

Turning now to FIG. 2, the functional blocks of the portable storage device are shown in a block diagram. The portable storage device 100 comprises a storage module 200, a processor 210, a, wireless circuitry 220 and a power module 230. Upon receipt of a signal it is processed by the wireless circuitry 220, and transmitted to the processor 210. The processor 210 controls writing of data to the storage module 200, and reading of data from the storage module 200. It can further control the wireless circuitry 220 to cause a signal to be transmitted.

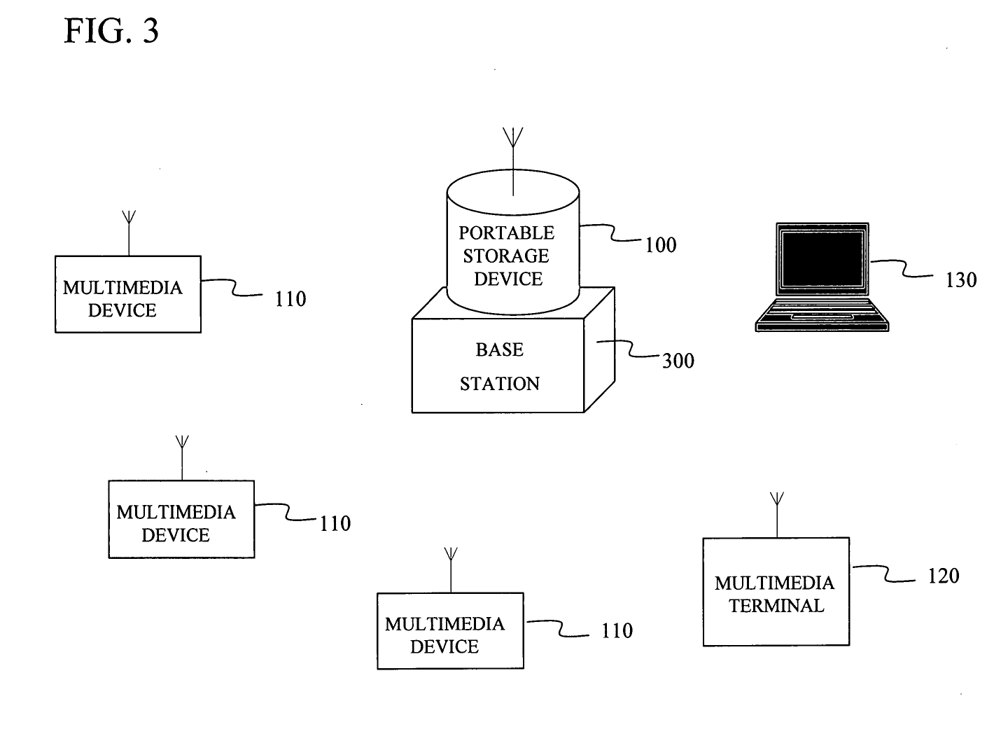

Turning now to FIG. 3, the portable storage device 100 is shown being attached to a base station 300. Said base station is functioned to enhance the performance of said portable storage device 100. According to one embodiment of the present invention, the base station 300 may include means for extending the activity range of the wireless communication between the portable storage device 100 and the other devices having wireless connectivity mentioned above, such as multimedia devices 110, multimedia terminal 120 and personal computer 130. Additionally, the base station 300 may be connected to the mains power for supplying power directly to the portable storage device 100 and for charging the power module 230. The base station 300 may further comprise an additional storage module for expanding the storage capacity of the portable storage device 100.

Numerous characteristics, advantages and embodiments of the invention have been described in detail in the foregoing description with reference to the accompanying drawings. However, the disclosure is illustrative only and it is to be understood that the invention is not limited to the precise illustrated embodiments. Various changes and modifications may be effected therein by one skilled in the art without departing from the scope or spirit of the invention.

What is claimed is:

1. A portable storage device having wireless connectivity, said device comprising:
means for storing data;
means for connecting to a wireless network, coupled to said means for storing data;
means for supplying electrical power to said portable storage device;
and wherein said means for connecting to a wireless network are configured to stream multimedia data between said means for storing data and at least one wireless device.

2. The device according to claim 1, wherein steaming is bi-directional.

3. The device according to claim 1, wherein streaming data between said means for storing data and a plurality of said devices having wireless connectivity is performed simultaneously.

4. The device according to claim 1, wherein said wireless network is one of the following communication protocols: IEEE 802.11x, Bluetooth, IrDA.

5. The device according to claim 1, wherein said wireless network in connected to the Internet.

6. The device according to claim 1, wherein said wireless device is one of the following: multimedia device, multimedia terminal, personal computer, personal device accessory (PDA), DVD, VCR, TV.

7. The device according to claim 1, wherein said portable storage device is capable of receiving and transmitting in multiple formats, and is used to interpret between at least two said devices having wireless connectivity, each holding data in a different format.

8. The device according to claim 6, wherein said device may be connected to a base station enabling at least one of the following: extending the activity range of said means for connecting to a wireless network, expanding the capacity of said means for storing data, charging said means for supplying electrical power.

9. A portable data storage device having wireless connectivity, said device comprising:
a storage module;
a processor;
a wireless circuitry;
a power unit;
wherein said processor is coupled to said storage module and to said wireless circuitry;
and wherein said processor is configured to command said wireless circuitry to stream multimedia data between said storage module and at least one wireless device.

10. The device according to claim 9, wherein said storage module comprises at least one of the following: magnetic hard disk drive, CD-RW, EEPROM, flash.

11. The device according to claim 9, wherein said wireless device is one of the following: multimedia device, multimedia terminal, personal computer, personal device accessory (PDA), TV.

12. The device according to claim 9, wherein said wireless circuitry is configured to operate in one of the following wireless communication protocols: IEEE 802.11xx, Bluetooth, IrDA.

13. The device according to claim 9, wherein said wireless circuitry is configured to bi-directional streaming.

14. The device according to claim 9, wherein said processor enables the simultaneous streaming of data between the data storage module and a plurality of said portable devices having wireless connectivity.

15. The device according to claim 9 wherein the device can be connected to a base station for enhanced performance.

16. The device according to claim 15 wherein said base station enables power unit charging.

17. The device according to claim 15 wherein said base station enables expanding the storage capacity.

18. The device according to claim 15 wherein said base station enables extending the wireless activity range of the portable data device.

19. The device according to claim 9, wherein said portable storage device is capable of receiving and transmitting in multiple formats, and is used to interpret between at least two said devices having wireless connectivity, each holding data in a different format.

20. The device according to claim 9, wherein said portable storage device is configured to serve as a virtual storage manager, and wherein the portable storage device is configured upon a request from a first wireless device, to relay requested data from a second wireless device to said first wireless device.

21. A method for streaming data over a wireless network comprising at least one wireless device and at least one portable storage device comprising a storage module, said method comprising the steps of:
(a) at least one wireless device sends a request for a multimedia data file;
(b) said portable storage device streams requested multimedia data file to at least one wireless device in accordance with the request

22. The method of claim 21 wherein streaming to a plurality of wireless device is performed simultaneously.

23. The method of claim 22 wherein multimedia data file is the same file streamed to each and every wireless device

24. The method of claim 22 wherein multimedia data file is different for each and every wireless device.

25. The method of claim 21 wherein step (a) further comprises: subsequently said portable storage device locates a wireless device on said network holding said requested multimedia data file and streams said multimedia data file to said storage module of said portable storage device.
